(19) United States
(12) Patent Application Publication
(10) Pub. No.: US 2007/0248091 A1
(43) Pub. Date: Oct. 25, 2007

(54) Methods and apparatus for tunnel stitching in a network

(76) Inventors: Mohamed Khalid, Cary, NC (US); Rajiv Asati, Morrisville, NC (US); Vijay Bollapragada, Cary, NC (US); Sunil Cherukuri, Morrisville, NC (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/409,586

(22) Filed: Apr. 24, 2006

(51) Int. Cl. H04L 12/56

(52) U.S. Cl. 370/392; 370/401

(57) ABSTRACT

An edge router (disposed between a packet-switched network and a label-switching network) is configured to receive an IKE message originating from a client on the Internet (e.g., packet-switched network) attempting to set up a tunnel. Upon receipt of the IKE message, the edge router utilizes a unique identifier in the IKE message to identify a virtual private network in the label-switching network. In lieu of terminating an IPSec tunnel at the edge router and performing a respective key exchange with the client, the edge router identifies a corresponding forwarding table associated with the virtual private network (identified by the unique identifier in the IKE message) and, based on the corresponding forwarding table, forwards the IKE message to a destination reachable via the label-switching network. The destination (e.g., a key server in a corresponding VPN) communicates with the client through the edge router to set up the tunnel.

### BACKGROUND

Computer networks typically provide a physical interconnection between different computers to allow convenient exchange of programs and data. A plurality of connectivity devices, such as switches and routers, interconnect each user computer connected to the network. The connectivity devices maintain routing information about the computers and perform routing decisions concerning message traffic passed between the computers via the connectivity devices. Each connectivity device, or router, corresponds to a network routing prefix indicative of the other computers, which it has direct, or indirect access to. Therefore, data routed from one computer to another follows a path through the network defined by the routers between the two computers.

The routers define nodes in a network, and data travels between the nodes in a series of so-called “hops” over the network. Since each router is typically connected to multiple other routers, there may be multiple potential paths between given computers. Typically, the routing information is employed in a routing table in each router, which is used to determine a path to a destination computer or network. The router makes a routing decision, using the routing table, to identify the next “hop,” or next router, to send the data to in order for it to ultimately reach the destination computer.

A so-called Virtual Private Network (VPN) is a network that uses a public telecommunication infrastructure, such as the Internet, to provide remote offices or individual users with secure access to their organization's network. A VPN works by using the shared public infrastructure while maintaining privacy through security procedures and tunneling protocols.

VPNs provide a secured means for transmitting and receiving data between network nodes even though a corresponding physical network supporting propagation of the data is shared by many users. Typically, the data transmitted between nodes (e.g., edge nodes of a service provider network) is encrypted to protect against eavesdropping and tampering by unauthorized parties.

One type of VPN is known as a 2547 based VPN, which allows a customer to offer VPN service using the notion of a Virtual Routing and Forwarding (VRF) instance. So-called PE (e.g., Provider Edge) routers typically maintain VRF information in one or more respective tables (e.g., a VRFs or forwarding tables) dictating how to route and forward traffic through the shared physical network to support corresponding VPNs for different customers.

In 2547 VPNs, PE routers advertise VPN prefixes and labels (VPN_LABEL) for these prefixes using Multi-Protocol Border Gateway Protocol (MP-BGP) in the control plane. In the forwarding plane, when an IP packet arrives into a VRF, the packet is appended with two labels (e.g., an Internal Gateway Protocol label (IGP_LABEL) and a VPN_LABEL). The IGP_LABEL gets the packet to a far end PE of a respective network. The VPN_LABEL associates the packet with the outgoing interface on the far end PE. 2547 VPNs inherently allow for “any2any” connectivity for a scalable VPN solution to connect thousands of sites. Many large enterprises use 2547 VPNs for segmentation purposes.

Enterprise customers (VPN customers) subscribing to 2547 based VPNs for site-to-site connectivity (e.g., site connectivity from a packet-switched network such as the Internet to virtual private network in a label-switching network) from a respective service provider sometimes also requires that the service provider provide IPSec VPN access to remote/mobile VPN clients/CPEs so that the remote clients could become a part of the VPN. For example, a deployment model (called ASWAN) requires that the service provider (associated with the label-switching network) provide ‘IPSec Termination’ functionality for each VPN customer at a junction (e.g., an edge router) between the packet-switched network and the label-switching network.

### SUMMARY

Conventional methods such as the ASWAN deployment model discussed above suffer from a number of deficiencies. For example, although the ASWAN deployment model is useful in certain circumstances to integrate remote access (from sites on the Internet) to 2547 based VPNs, the ASWAN deployment model discussed above has an associated disadvantage of taking the IPSec processing (which is deemed critical to a secured enterprise network) “away” from the Enterprises themselves and placing such a burden in the hands of an edge router controlled by the service provider. In other words, a service provider's autonomous system border router (e.g., an ASBR or provider edge router) associated with a respective service provider network must handle IPSec processing for Internet-based clients attempting to access a virtual private network site through the provider edge router. This means that the provider edge router becomes an IPSec terminating device and must be involved in a key exchange with a requesting client on the Internet attempting to access a virtual private network in the enterprise environment (e.g., label-switching network). Accordingly, the ASBR provider edge router must manage and distribute keys on behalf of an owner of the enterprise. VPN customers prefer to retain control and distribution of their private key information since improper dissemination of the keys could result in a misappropriation of their secure data.

In addition to having to managing a key exchange according to conventional techniques, the ASBR provider edge router within the service provider network can become a “bottleneck” since such a provider edge router in the service provider network would have to decrypt and re-encrypt messages received over the Internet before forwarding such packets over the service provider network (e.g., a label-switching network) to an appropriate virtual private network enterprise site. In other words, the client and the provider edge router communicate with each other via use of a set of keys. In a return path to the client, the provider edge router must properly encrypt messages for the client.

Typically, a provider edge router receiving packets from clients can handle only several thousand IPSec sessions due to restrictions on processing bandwidth. As a result, the functionalities needed at the ASBR provider edge router are increased, driving up the cost and complexity of such a system. Needless to say, management of keys and/or carrying out a security policy by the service provider at a provider edge router (on behalf of a customer) increases the vulnerability of a respective enterprise network.

Techniques discussed herein deviate with respect to conventional applications such as those discussed above as well as other techniques known in the prior art. For example, embodiments herein include techniques for providing a virtualized IPSec stitching function enabling remote virtual private network access. For example, a provider edge router according to embodiments herein performs a so-called stitching function to map the IPSec packets from remote clients (in a packet-switched network) to a relevant VPN or enterprise site (in a label-switching network) without revealing the IP addresses of individual VPN customers' remote clients.

For example, one embodiment herein includes a data communication device (e.g., a provider edge router) that supports data flows between a first type of network (e.g., a packet-switched network such as the Internet) and a second type of network (e.g., a service provider network such as a label-switching network). The data communication device is configured to receive a message (e.g., an IKE message) originating from a source node such as a client on the Internet attempting to set up a tunnel between the client (on the Internet) and an enterprise IPSec virtual private network gateway (e.g., a key server) in the service provider network.

Upon receipt of the (IKE) message, the data communication device utilizes a unique identifier (e.g., an IKE identifier) in the message to identify a virtual private network (e.g., an enterprise site) associated with the service provider network. In lieu of terminating an IPSec tunnel at the data communication device (e.g., at a provider edge router) and performing a respective key exchange with the client, the data communication device identifies and utilizes a corresponding forwarding table associated with the virtual private network (VPN) identified by the unique identifier in the IKE message and forwards the IKE message to a destination reachable through the service provider network. Techniques herein enable a same destination address to be used as the IPSec termination endpoint within more than one VPN as well as on the data communication device.

In one embodiment, the data communication device forwards a received message to a key server or enterprise IPSec virtual private network gateway (reachable through the service provider network) managed by a respective customer or owner. Accordingly, the customer can manage and implement its own unique security policy without having to offload such a task onto the data communication device (e.g., provider edge router) disposed between the first and second types of networks.

In further embodiments, upon receipt of the (IKE) message from the source node (in the Internet), the data communication device installs or modifies a respective routing or forwarding table (of the data communication device) to include a (unicast) route path to the source node to enable the data communication device to, in a reverse direction, forward return communications received from the destination (e.g., key server or gateway) in the service provider network back to the source node. In addition to modifying a respective VRF or forwarding table in the data communication device for an appropriate virtual private network, the data communication device can advertise the (unicast) route path to the virtual private network in the service provider network as identified by the unique identifier. Accordingly, a key server associated with the virtual private network receiving the advertisement will be able to forward responses associated with the (IKE) message back through the data communication device to an initiating client.

Techniques herein are well suited for use in applications such as those enabling remote entities (e.g., clients, customer premises equipment including terminating equipment, such as terminals, telephones, and modems, supplied by the telephone company, installed at customer sites, and connected to the telephone company network, any telephone equipment residing on the customer site) in a packet-switched network environment such as the Internet to access virtual private network sites in a label-switching network. However, it should be noted that configurations herein are not limited to such use and thus configurations herein and deviations thereof are well suited for use in other environments as well.

In addition to the embodiments discussed above, other embodiments herein include a computerized device (e.g., a host computer, workstation, etc.) configured to support the techniques disclosed herein such as providing mapping and related functions to enable remote (client) access to virtual private networks managed by a respective service provider. In such embodiments, the computerized device such as a mapping system includes a memory system, a processor (e.g., a processing device), an optional display device, and an interconnect connecting the processor and the memory system. The interconnect can support communications with the optional display device (e.g., display screen or display medium). The memory system is encoded with an application that, when executed on the processor, generates a mapping process (as well as related processes) according to techniques herein.

Yet other embodiments of the present disclosure include software programs to perform the method embodiment and operations summarized above and disclosed in detail below in the Detailed Description section of this disclosure. More specifically, one embodiment herein includes a computer program product (e.g., a computer-readable medium). The computer program product includes computer program logic (e.g., software instructions) encoded thereon. Such computer instructions can be executed on a computerized device to support mapping according to embodiments herein. For example, the computer program logic, when executed on at least one processor associated with a computing system, causes the processor to perform the operations (e.g., the methods) indicated herein as embodiments of the present disclosure. Such arrangements as further disclosed herein are typically provided as software, code and/or other data structures arranged or encoded on a computer readable medium such as an optical medium (e.g., CD-ROM), floppy or hard disk, or other medium such as firmware or microcode in one or more ROM or RAM or PROM chips or as an Application Specific Integrated Circuit (ASIC). The software or firmware or other such configurations can be installed on a computerized device to cause one or more processors in the computerized device to perform the techniques explained herein.

Yet another more particular technique of the present disclosure is directed to a computer program product that includes a computer readable medium having instructions stored thereon for facilitating remote access to virtual private networks in a respective service provider network environment. The instructions, when carried out by a processor of a respective computer device, cause the processor to perform the steps of: i) receiving a message originating from a source node in a first type of network (e.g., a packet-switched network), the message including a request to create a secured connection between the source node in the first type of network and a destination in a second type of network (e.g., a service provider network such as a label-switching network); ii) in response to receiving the message, utilizing a unique identifier in the request message to identify a virtual private network associated with the second type of network; and iii) utilizing a corresponding forwarding table associated with the virtual private network identified by the unique identifier for purposes forwarding the message to the destination in the second type of network. Other embodiments of the present application include software programs to perform any of the method embodiment steps and operations summarized above and disclosed in detail below.

It is to be understood that the embodiments of the invention can be embodied strictly as a software program, as software and hardware, or as hardware and/or circuitry alone, such as within a data communications device. For example, the techniques as explained herein, can be employed in data communications devices and/or software systems for such devices such as those manufactured by Cisco Systems, Inc. of San Jose, Calif.

### BRIEF DESCRIPTION OF THE DRAWINGS

The foregoing and other objects, features, and advantages of the present application will be apparent from the following more particular description of preferred embodiments of the present disclosure, as illustrated in the accompanying drawings in which like reference characters refer to the same parts throughout the different views. The drawings are not necessarily to scale, with emphasis instead being placed upon illustrating the embodiments, principles and concepts.

FIG. 1 is a diagram illustrating an environment for establishing secured connections according to an embodiment herein.

FIG. 2 is a diagram of a mapping function for establishing secured connections between sources and destinations residing in different types of networks using a mapping function according to an embodiment herein.

FIG. 3 is a diagram of an example platform for executing a mapping function according to embodiments herein.

FIG. 4 is a flowchart illustrating techniques of utilizing a mapping function according to embodiments herein.

FIGS. 5 and 6 combine to form a more detailed flowchart illustrating mapping techniques according to embodiments herein.

### DETAILED DESCRIPTION

According to one embodiment, a data communication device such as an edge router (disposed between a packet-switched network and a label-switching network) is configured to receive an message (e.g., an IKE message or any type of request or key exchange message) originating from a client on the Internet (e.g., packet-switched network) attempting to set up a tunnel. Upon receipt of the (IKE) message, the data communication device utilizes a unique identifier in the IKE message to identify a virtual private network in the label-switching network.

In lieu of terminating an IPSec tunnel at the edge router and performing a respective key exchange with the client, the data communication device receiving the (IKE) message identifies a corresponding forwarding table associated with the virtual private network identified by the unique identifier in the (IKE) message. Based on the corresponding forwarding table, the data communication device forwards the (IKE) message to a destination in the label-switching network. The destination (e.g., a key server in a corresponding service provider network) communicates with the client through the data communication device router to set up the tunnel.

In one embodiment, the data communication device forwards the (IKE) message to a key server or enterprise IPSec virtual private network gateway (in the service provider network) managed by a respective customer or owner. Accordingly, the customer can manage and implement its own unique security policy without having to offload such a task onto the data communication device (e.g., provider edge router) disposed between the first and second types of networks. In other words, the destination in the service provider network can initiate an exchange of key information with the client in lieu of the data communication device acting on behalf of the customer or owner to manage a key exchange with the client.

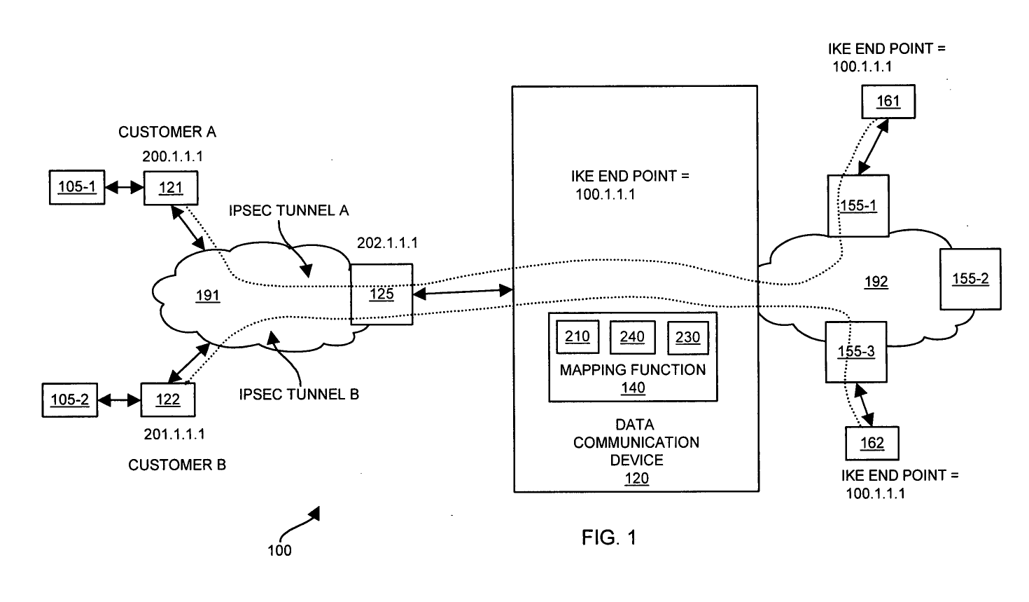

FIG. 1 is a block diagram of a network environment 100 including a data communication device 120 according to an embodiment herein. As shown, network environment 100 includes customer equipment 105-1, customer equipment 105-2, data communication device 121, data communication device 122, network 191, gateway 125, data communication device 120, network 192, provider edge router 155-1, provider edge router 155-2, provider edge router 155-3, destination 161, and destination 162. Data communication device 120 includes mapping function 140. Mapping function 140 includes unique identifier information 210, forwarding table information 240, and target destination information 230.

In the context of one embodiment, network 191 is a first type of network such as a packet-switched network (e.g., the Internet). Network 192 is a label-switching network such as that based upon MPLS (Multiple-Protocol Label Switching). Note that according to other embodiments herein, network 191 and network 192 can be any type of network. For example, network 192 can be a packet-switched network (e.g., the Internet), label-switching network, etc.

In general, data communication device 121 enables customer equipment 105-1 such as clients, computers, routers, gateways, customer premises equipment including terminating equipment, terminals, telephones, modems telephone equipment, networks, etc. to communicate through data communication device 121 (e.g., a data communication device, router, gateway, virtual private network, etc.) over network 191 through gateway 125 to data communication device 120 (which is operated by a service provider). Data communication device 120 (e.g., a provider edge router associated with network 192) enables the customer equipment 105-1 communicating through data communication device 121 to access virtual private networks associated with network 192. In one embodiment, the virtual private networks in network 192 support access to corresponding repositories in network 192 storing confidential information. Establishment of one or more secured communication channels between customer equipment 105-1 and one or more destinations such as target repositories associated with network 192 ensures that conveyed data cannot be read or compromised by any individuals without appropriate authorization. In a similar way, customer equipment 105-2 also can access corresponding data in another set of one or more repositories associated with network 192 over respective virtual private networks.

In one embodiment, a respective service provider (e.g., associated with network 192) supports separate virtual private networks in network 192 for each of multiple customers. Accordingly, a customer such as a bank can utilize its respective resources such as customer equipment 105-1 to access its own set of one or more repositories attached to network 192 through data communication device 120 while a customer such as a pharmacy can utilize its respective resources such as customer equipment 105-2 to access its own set of one or more repositories attached to network 192 through data communication device 120 without any data security breaches.

As discussed above, conventional methods of providing secured links involved a process of terminating an IPSec session at the data communication device 120. For example, data communication device 120 would maintain and implement security policies on behalf of respective customers. This meant that the service provider had to configure the data communication device 120 to be an IKE termination device. Such a configuration required the customer to entrust the data communication device 120 with appropriate encryption keys to support communications with respective clients over network 191 as well as perform an encryption/decryption process on behalf of the customer.

Embodiments herein involve providing a mapping function 140 in data communication device 120 such that the service provider need not be entrusted with one or more respective customers' encryption keys. Accordingly, a respective customer can utilize its own equipment as IKE termination devices for purposes of providing secured links between a source on network 191 and a respective destination on network 192. This eliminates the need for the data communication device 120 to perform complex IPSec processing (e.g., encryption and decryption) of data packets sent between network 191 and network 192. That is, the data communication device 120 can forward respective packets in a similar manner as other packets.

In general, embodiments herein provide a mechanism to offload IPSec processing to individual VPNs in the service provider network (e.g., network 192) by stitching IPSec tunnels without “revealing” an identity of IPSEC_Termination devices via network 191 such as the Internet.

More specifically, embodiments herein address the problem discussed in the background section by enabling data communication device 120 (e.g., a Gateway ASBR) to stitch the received IPSec packets from the global context into Customer VRF (VPN Routing and Forwarding) contexts and vice versa. This present disclosure also addresses the Enterprises's (e.g., customer's) desire to keep the IPSEC (Internet Protocol Security) termination within its control without incurring any additional complexity.

Consider the following typical Enterprise network as in FIG. 1. A customer subscribes to MPLS/VPN (e.g., via network 192 such as that based on Request For Comment 2547). The customer maintains equipment (e.g., a key exchange server, repositories of information, networks, etc.) attached to network 192 (through one or more provider edge router 155) to handle remote IPSEC access at one of its VPN sites in network 192, where a corresponding IPSec_Termination device (e.g., a key exchange server) is located. In this example, assume that destination 161 is the IPSec_Termination_Device.

Each customer equipment (e.g., CPE/Client such as customer equipment 105-1 and/or customer equipment 105-2) gets configured with IPSec_end_Point=data communication device 120 as was the case according to conventional methods. The customer equipment initiates an IKE session based on transmission of a respective message to data communication device 120. The data communication device 120 is pre-configured with mapping function 140, which effectively the received IKE message in the relevant VRF based on the IKE_ID as per Request For Comment 2407.

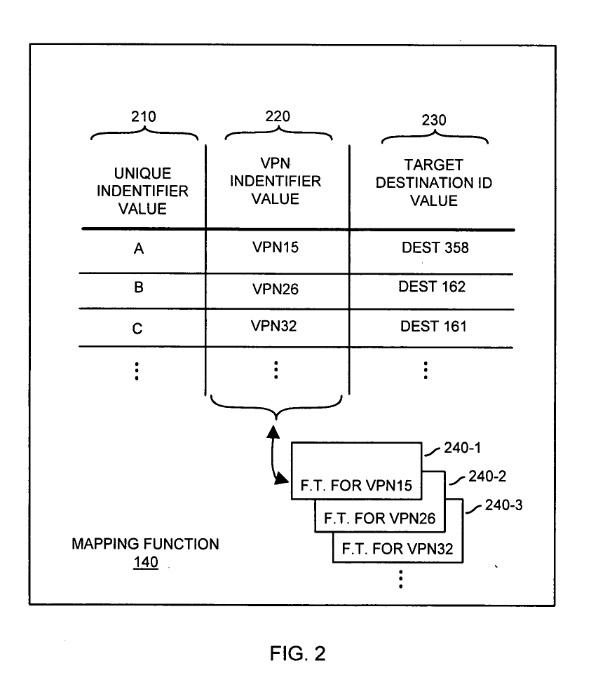

In the embodiment shown in FIG. 2, the mapping function 140 provides a mapping of unique identifiers 210 (e.g., IKE identifier values) to respective virtual private networks 220, and target destinations 230 in network 192. Each virtual private network 220 in network 192 has an associated forwarding table 240 (e.g., a VRF) for forwarding data packets to network 191 and network 192.

Upon receipt of an IKE message at data communication device 120, the data communication device 120 retrieves a respective unique identifier value in the received message. The data communication device 120 then uses mapping function 140 to identify a corresponding virtual private network associated with the unique identifier and/or a target destination in the respective virtual private network in which to forward the received message. To forward a message to a respective target destination in network 192, the data communication device 120 uses the appropriate forwarding table 240. For example, if a message received from customer equipment 105-1 (e.g., a client such as an employee working from home) includes the unique identifier value C, the data communication device would utilize mapping function 140 to identify that customer equipment 105-1 is attempting to create a secured connection with destination 161 in virtual private network 32 in network 192. Accordingly, data communication device 120 utilizes forwarding table 240-3 (e.g., a VRF associated with virtual private network 32) to route the received message to destination 161 (e.g., a key exchange server). The destination 161 acts as a termination device for the secured link in lieu of data communication device 120 being a respective termination device.

In response to receiving an IKE message, the data communication device 120 will inject a route (e.g., a path back to the respective customer equipment) within a relevant forwarding table. For example, in the above example, the data communication device 120 will inject (e.g., create and store) a return path in forwarding table 240-3 back to customer equipment 105-1. Consequently, when a destination provides a response to a received message, the data communication device 120 is able to forward the response back to the appropriate source (e.g., customer equipment) that generates the message to the destination in the virtual private network. In addition to updating a respective forwarding table to include routing information back to the requesting client, the data communication device 120 advertises the return route (back to the requesting source) to a corresponding virtual private network in network 192. Accordingly, a destination device and/or member nodes in the respective virtual private network can update its forwarding tables allowing the destination (e.g., an IPSec_Termination device and/or member nodes) to respond to the IKE message directly to the appropriate customer equipment through network 192.

Subsequent messages between the customer equipment and a respective destination device enable an exchange IPSec Security Associations. Such an exchange enables the customer equipment to send encrypted packets to data communication device 120, which provides the “Virtualized IPSec Tunnel Stitching” by passing IPSec packets from the global context (associated with network 191) into a relevant VRF context (associated with network 192) and vice versa. Accordingly, the service provider can advertise only one public IP address on network 191 irrespective of number of VPNs desiring remote Access VPN.

Moreover, since destinations such as the IPSec_termination devices are now within the relevant VRFs (e.g., forwarding table) which need not be revealed to users of network 191, the different destination devices (e.g., destination 161 and destination 162) in network 192 can safely use overlapping addresses. In other words, a destination 161 can have the same associated address as destination 162 because the destinations reside on two different virtual private networks having unique respective forwarding tables 240.

The embodiments as discussed above and as will be discussed later in this specification provide advantages over conventional methods. For example, embodiments herein free up data communication device 120 (e.g., an Autonomous System Border Router) from the complex IPSec processing required on each packet. The data communication device 120 then needs only to deal with forwarding the IKE messages (e.g., one or more packets) like any other packet. Additionally, i) an enterprise (and/or service provider) doesn't need to assign a publicly routeable address to every “IPSec Termination Device” anymore because the same IP address can be reused for different customers; ii) a customer or enterprise need not purchase rights to use an additional interface from the service provider for mere IPSec control plane processing; iii) the service provider associated with network 192 can offer “managed IPSEC termination service” as a revenue-generating service; and iv) this technique scales well and doesn't require any changes to the CPE_Client (e.g., the customer equipment utilizes a same protocol as in the conventional methods as discussed above to set up a secured link with a target in network 192).

As discussed above, one aspect of the present disclosure is about a framework to associate a received IKE packet from customer equipment with a respective VRF (e.g., a forwarding table) based on an “identification” entity at the data communication device 120. Based on mapping function 140, the IKE packet is simply forwarded to actual IPSec endpoint within a virtual private network specified by an identifier (e.g., an IKE identifier) in the message received from customer equipment of network 191.

In a so-called aggressive mode, the “identification” entity could be the “IKE_ID” in the message received from the customer equipment. In a so-called main mode, the “identification” entity could be the combination of Source and Destination IP address of a message received from the customer equipment.

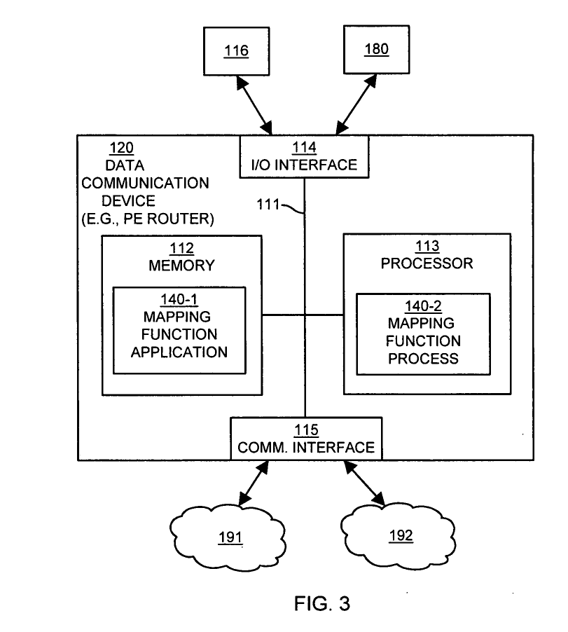

FIG. 3 is a block diagram illustrating an example computer system (e.g., a data communication device 120) for executing mapping function 140 and other related processes (e.g., source node functionality, destination node functionality, etc.) according to embodiments herein. Data communication device 120 can be a computerized device such as a personal computer, workstation, portable computing device, console, network terminal, processing device, provider edge router, etc.

As shown, computer system 120 of the present example includes an interconnect 111 that couples a memory system 112, a processor 113, an I/O interface 114, and a communications interface 115. Peripheral devices 116 (e.g., one or more optional user controlled devices such as a keyboard, mouse, display screens, etc.) can couple to data communication device through I/O interface 114. I/O interface 114 enables data communication device 120 to access repository 180 and display configuration information on a display screen if so equipped.

Communications interface 115 enables data communication device 120 to initiate communications over different types of networks such as network 191 and network 192 to transmit and receive information from different resources (e.g., source nodes in network 191 and destination nodes in network 192, etc.).

As shown, memory system 115 is encoded with mapping function application 140-1 supporting forwarding of request messages received from source nodes of network 191 to respective destination nodes of network 192 for purposes of setting up secured connections (e.g., tunnels) between the source nodes and destination nodes. Mapping function application 140-1 can be embodied as software code such as data and/or logic instructions (e.g., code stored in the memory or on another computer readable medium such as a disk) that support functionality according to different embodiments described herein.

During operation, processor 110 of data communication device 120 accesses memory system 112 via the interconnect 111 in order to launch, run, execute, interpret or otherwise perform the logic instructions of the mapping function application 140-1. Execution of mapping function application 140-1 produces processing functionality in mapping function process 140-2. In other words, the mapping function process 140-2 represents one or more portions of the mapping function application 140-1 (or the entire application) performing within or upon the processor 113 in the data communication device 120.

It should be noted that the mapping function 140 as discussed above (and as will be discussed further below) can be executed in an environment such as data communication device 120. Mapping function 140 can be represented by either one or both of the mapping function application 140-1 and/or the mapping function process 140-2. For purposes of this discussion and different embodiments herein, general reference will again be made to the mapping function 140 as performing or supporting the various steps and functional operations as previously discussed and as will be discussed further in this specification.

It should be noted that, in addition to the mapping function process 140-2, embodiments herein include the mapping function application 140-1 itself (i.e., the un-executed or non-performing logic instructions and/or data). The mapping function application 140-1 can be stored on a computer readable medium such as a floppy disk, hard disk, or optical medium. The mapping function application 140-1 can also be stored in a memory type system such as in firmware, read only memory (ROM), or, as in this example, as executable code within the memory system 112 (e.g., within Random Access Memory or RAM). In addition to these embodiments, it should also be noted that other embodiments herein include the execution of mapping function application 140-1 in processor 113 as the mapping function process 140-2. Thus, those skilled in the art will understand that the data communication device can include other processes and/or software and hardware components, such as an operating system that controls allocation and use of hardware resources associated with the data communication device 120.

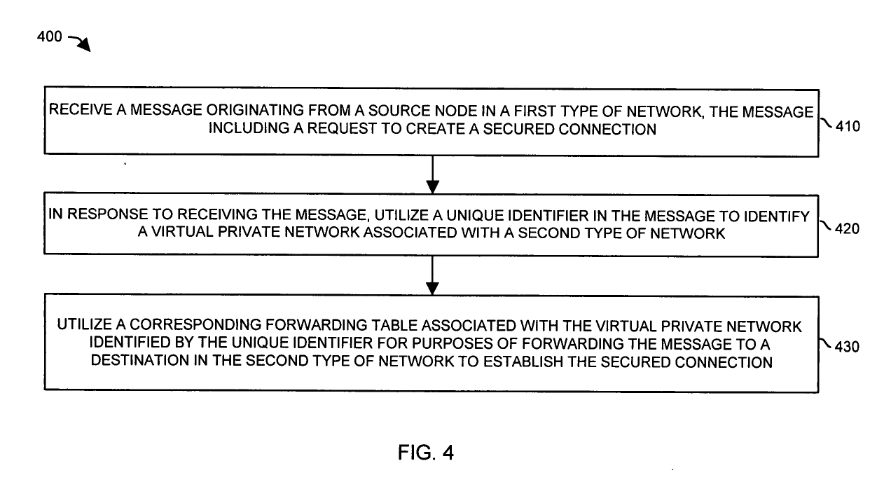

Functionality supported by data communication device 120 such as mapping function 140 will now be discussed with respect to flowcharts in FIGS. 4-6. For purposes of this discussion, data communication device 120 or, more particularly, mapping function 140 (or related functions) generally perform steps in the flowcharts at run-time. The functionality associated with mapping function 140 can be extended to the other entities as well. Also, note that the steps in the below flowcharts need not always be executed in the order shown.

Now, more particularly, FIG. 4 is a flowchart 400 illustrating a technique of utilizing mapping function application 140 to forward request messages received from source nodes of network 191 to respective destination nodes of network 192 for purposes of setting up corresponding secured connections (e.g., tunnels) between source nodes (e.g., customer equipment 105-1 and/or data communication device 121) and destination nodes (e.g., data communication device 155 and/or destination 161, 162, etc.) according to an embodiment herein. Note that techniques discussed in flowchart 400 overlap and summarize some of the techniques discussed above.

In step 410, the data communication device 120 (e.g., provider edge router) receives a message originating from a source node (e.g., customer equipment 105-1) in a first type of network such as network 191. As previously discussed, the message from the customer equipment 105 includes a request to create a secured connection with a virtual private network in network 192.

In step 420, via mapping function 140, the data communication device 120 utilizes a unique identifier (e.g., an IKE identifier, source and destination address, etc.) in the message to identify a virtual private network associated with network 192 in response to receiving the message.

In step 430, the data communication device 120 utilizes a corresponding one of multiple forwarding tables 240 associated with a virtual private network identified by the unique identifier in a received message for purposes of forwarding the message to a destination in the network 192 to establish or initiate establishment of the secured connection.

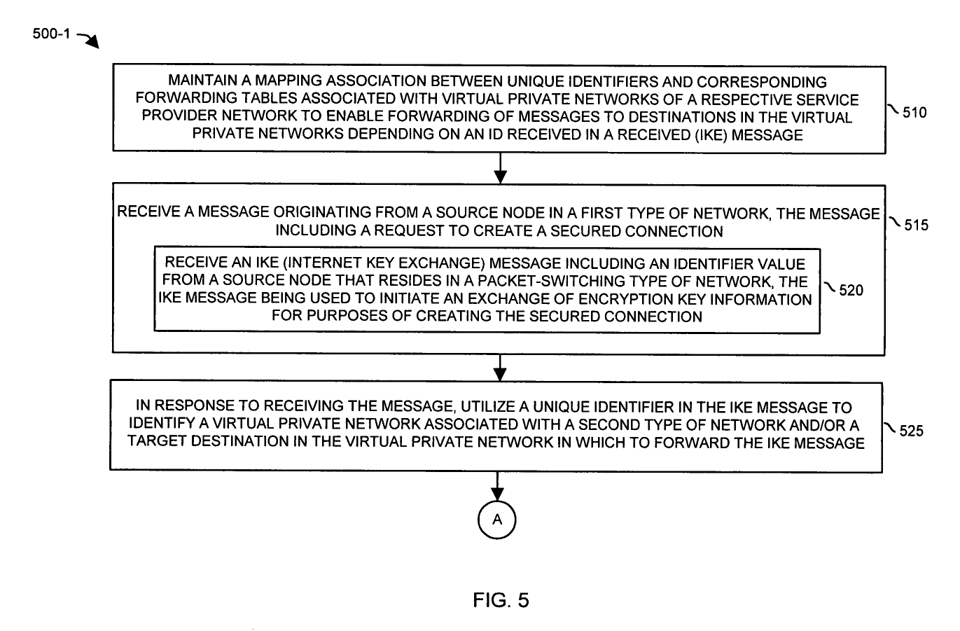

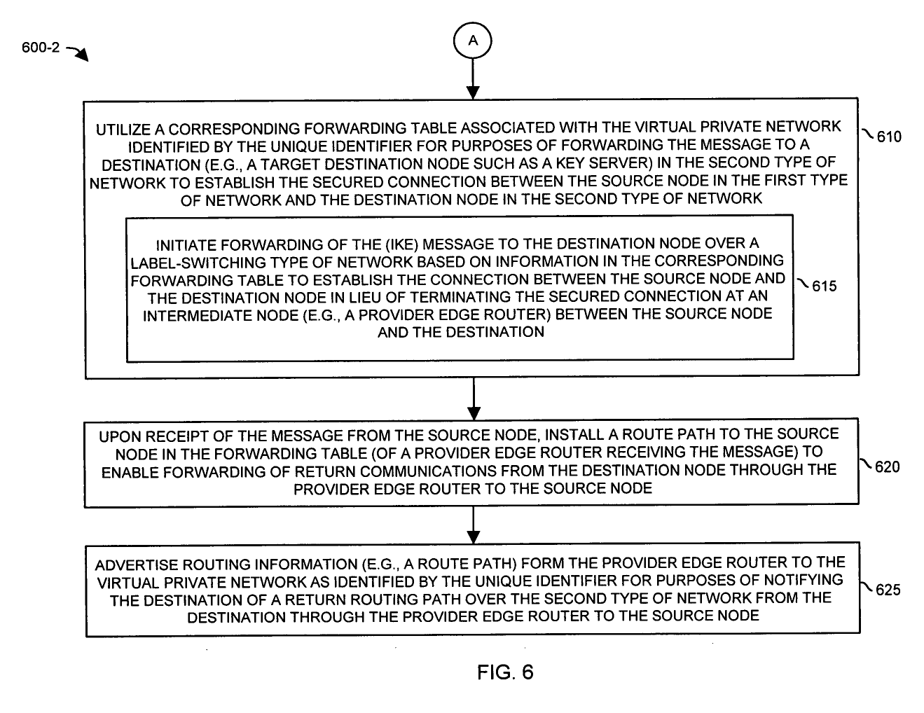

FIGS. 5 and 6 combine to form a flowchart 500 (e.g., flowchart 500-1 and flowchart 500-2) illustrating processing steps associated with mapping function 140 according to an embodiment herein. Note that techniques discussed in flowchart 500 overlap with the techniques discussed above in the previous figures.

In step 510, the data communication device 120 maintains a mapping association (in mapping function 140) between unique identifiers and corresponding forwarding tables 240 associated with virtual private networks of a respective service provider network (e.g., network 192) to enable forwarding of messages to destinations in the virtual private networks depending on an identifier received in a request message.

In step 515, the data communication device 120 receives a message originating from a source node in a first type of network 191. The message includes a request to create a secured connection.

In sub-step 520 associated with step 515, the data communication device 120 receives an (IKE) message including an (IKE) identifier value from a source node that resides in a packet-switching type of network such as network 191. In one embodiment, the IKE message is used by the source (e.g., customer equipment) to initiate an exchange of encryption key information with a destination in network 192 for purposes of creating a secured connection.

In step 525, the data communication device 120 utilizes a unique identifier (e.g., the IKE identifier value) in the message to identify a virtual private network associated with a second type of network and/or a target destination in the virtual private network in which to forward the received message.

In step 610 of flowchart 500-2 in FIG. 6, the data communication device 120 utilizes a corresponding forwarding table associated with the virtual private network identified by the unique identifier for purposes of forwarding the message to a destination (e.g., a target destination node such as a key server) in the second type of network 192 to establish the secured connection between the source node in the first type of network 191 and the destination node in the second type of network 192.

In step 615, the data communication device 120 initiates forwarding of the (IKE) message to the destination node over (a label-switching type of) network 192 based on information in the corresponding forwarding table associated with the corresponding virtual private network to establish the connection between the source node and the destination node in lieu of terminating the secured connection at the data communication device 120 (e.g., an intermediate node or provider edge router between the source node and the destination).

In step 620, upon receipt of the message from the source node, the data communication device 120 installs a route path to the source node in the forwarding table (of a provider edge router receiving the message) to enable forwarding of return communications from the provider edge router (e.g., data communication device 120) to the source node.

In step 625, the data communication device 120 advertises routing information (e.g., a route path) to a corresponding virtual private network as identified by the unique identifier for purposes of notifying the destination (and potentially other entities in network 192 as well) of a return routing path from the destination over network 192 through the data communication device 120 back to the source node in network 191.

As discussed above, techniques herein are well suited for use in applications such as those that support mapping or conversion functions. However, it should be noted that configurations herein are not limited to such use and thus configurations herein and deviations thereof are well suited for use in other environments as well.

While this invention has been particularly shown and described with references to preferred embodiments thereof, it will be understood by those skilled in the art that various changes in form and details may be made therein without departing from the spirit and scope of the present application as defined by the appended claims. Such variations are covered by the scope of this present disclosure. As such, the foregoing description of embodiments of the present application is not intended to be limiting. Rather, any limitations to the invention are presented in the following claims. Note that the different embodiments disclosed herein can be combined or utilized individually with respect to each other.

We claim:

1. A method comprising:
receiving a key exchange request message originating from a source node in a first type of network, the key exchange request message including a request to create a secured connection using encryption keys;
in response to receiving the key exchange request message, utilizing a unique identifier in the key exchange request message to identify a virtual private network associated with the second type of network; and
in lieu of responding to the key exchange request message and providing encryption key information to the source node, utilizing a corresponding forwarding table associated with the virtual private network identified by the unique identifier for purposes forwarding the key exchange request message to a destination in the second type of network to establish the secured connection.

2. A method as in claim 1 further comprising:
maintaining a mapping association amongst the unique identifier, the destination, and the corresponding forwarding table associated with the virtual private network to enable forwarding of the key exchange request message to the destination in the virtual private network.

3. A method as in claim 1, wherein receiving the key exchange request message from the source node includes receiving an IKE (Internet Key Exchange) message from the source node that resides in a packet-switching type of network, the IKE message being used to initiate an exchange of encryption key information for purposes of creating the secured connection.

4. A method as in claim 3, wherein forwarding the key exchange request message to the destination includes continuing forwarding of the IKE message to the destination over a label-switching type of network based on information in the corresponding forwarding table.

5. A method as in claim 4, wherein forwarding the key exchange request message to the destination occurs in lieu of terminating the secured connection at an intermediate node between the source node and the destination, the method further comprising:
utilizing a same overlapping address on both the destination node as well as the intermediate node.

6. A method as in claim 1, wherein forwarding the key exchange request message to the destination occurs in lieu of terminating the secured connection at an intermediate node between the source node and the destination.

7. A method as in claim 1 further comprising:
advertising routing information to the virtual private network for purposes of notifying the destination of a return routing path through the second type of network from the destination to the source node.

8. A method as in claim 1, wherein receiving the key exchange request message includes receiving the key exchange request message from the source node that transmitted the key exchange request message over a packet-switched type of network to an edge router associated with the second type of network; and
wherein utilizing the unique identifier in the request key exchange request message to identify the virtual private network associated with the second type of network includes utilizing the unique identifier in the key exchange request message at the edge router to identify a key exchange server in a label-switching network environment in which to forward the key exchange request message from the edge router to the destination.

9. A method as in claim 1, wherein forwarding the key exchange request message to the destination node in the second type of network alleviates an intermediate node other than the destination in the virtual private network from having to engage in a key exchange with the source node for purposes of establishing the secured connection.

10. A method as in claim 1, wherein forwarding the key exchange request message to the destination in the second type of network includes forwarding the key exchange request message to a key server in the second type of network.

11. A method as in claim 1 further comprising:
upon receipt of the key exchange request message from the source node, installing a route path to the source node in the corresponding forwarding table to enable forwarding of return communications from the destination to the source node; and
advertising the route path to the virtual private network identified by the unique identifier.

12. A method as in claim 1 further comprising:
initiating a stitching function with respect to the corresponding forwarding table to map the key exchange request message from the source node to the virtual private network, utilization of the stitching function preventing dissemination of specific address or other information associated with the destination to entities in the first type of network.

13. A method comprising:
receiving a key exchange request message from a source node in a first type of network, the key exchange request message being transmitted by the source node to initiate communications with an edge router between the first type of network and a second type of network for purposes of creating a secured connection using encryption keys; and
in lieu of terminating the secured connection at the edge router, utilizing a forwarding table maintained by the edge router to forward the key exchange request message to a destination node in the second type of network for purposes of enabling a key exchange between the source node and the destination node through the edge router.

14. A data communication device supporting data flows between a first type of network and a second type of network, the data communication device being configured to: i) receive a key exchange request message originating from a source node in the first type of network, ii) utilize a unique identifier in the key exchange request message to identify a virtual private network associated with the second type of network; and iii) identify a corresponding forwarding table associated with the virtual private network identified by the unique identifier, and iv) in lieu of responding to the key exchange request message and providing encryption key information, forward the key exchange request message to a destination in the second type of network to create a secured connection between the source node in the first type of network and the destination in the second type of network using encryption keys.

15. A data communication device as in claim 14, wherein the first type of network is a packet-switched network and the second type of network is at least one of a label-switching network and a packet-switched network.

16. A data communication device as in claim 15, wherein the key exchange request message is an IKE (Internet Key Exchange) message including an IKE identifier associated with a corresponding IKE aggressive mode, the IKE message originated by the source node, the IKE message being used to initiate an exchange of encryption key information for purposes of creating the secured connection.

17. A data communication device as in claim 16, which is configured to forward the key exchange request message to the destination in lieu of terminating the secured connection at the data communication device.

18. A data communication device as in claim 14 configured to forward the key exchange request message to a key server in the second type of network in lieu of initiating a process to exchange key information between the data communication device and the source node.

19. A data communication device as in claim 14 configured to install a route path to the source node in the corresponding forwarding table to enable forwarding of return communications from the destination to the source node.

20. A data communication device as in claim 19 configured to advertise the route path to network nodes associated with the virtual private network.

21. A computer program product including a computer-readable medium having instructions stored thereon for processing data information, such that the instructions, when carried out by a processing device, enable the processing device to perform the steps of:
receiving a key exchange request message originating from a source node in a first type of network, the key exchange request message including a request to create a secured connection between the source node in the first type of network and a destination in a second type of network;
in response to receiving the key exchange request message, utilizing a unique identifier in the request key exchange request message to identify a virtual private network associated with the second type of network; and
in lieu of responding to the key exchange request message and providing encryption key information to the source node, utilizing a corresponding forwarding table associated with the virtual private network identified by the unique identifier for purposes forwarding the key exchange request message to the destination in the second type of network.

22. A computer program product as in claim 21, wherein receiving the key exchange request message from the source node includes receiving an IKE (Internet Key Exchange) message from the source node that resides in a packet-switching type of network, the IKE message being used to initiate an exchange of encryption key information for purposes of creating the secured connection; and
wherein forwarding the key exchange request message to the destination includes initiating forwarding of the IKE message to the destination over a label-switching type of network based on information in the corresponding forwarding table in lieu of terminating the secured connection at an intermediate node between the source node and the destination.

23. A computer program product as in claim 21, wherein receiving the key exchange request message includes receiving the key exchange request message from the source node that transmitted the key exchange request message over a packet-switched type of network to an edge router associated with the second type of network; and
wherein utilizing the unique identifier in the request key exchange request message to identify the virtual private network associated with the second type of network includes utilizing the unique identifier in the key exchange request message at the edge router to identify a key exchange server in a label-switching network environment in which to forward the key exchange request message from the edge router to the destination.

24. A computer system comprising:
a processor;
a memory unit that stores instructions associated with an application executed by the processor; and
an interconnect coupling the processor and the memory unit, enabling the computer system to execute the application and perform operations of:
receiving a key exchange request message originating from a source node in a first type of network, the key exchange request message including a request to create a secured connection between the source node in the first type of network and a destination in a second type of network;
in response to receiving the key exchange request message, utilizing a unique identifier in the key exchange request message to identify a virtual private network associated with the second type of network; and
in lieu of responding to the key exchange request message and providing encryption key information to the source node, utilizing a corresponding forwarding table associated with the virtual private network identified by the unique identifier for purposes forwarding the key exchange request message to the destination in the second type of network.

25. A computer readable medium having computer readable code thereon, the computer-readable medium comprising:
instructions for transmitting a key exchange request message originating from a source node in a first type of network to a data communication device, the data communication device configured to:
receive the key exchange request message originating from the source node;
in response to receiving the key exchange request message, utilize a unique identifier in the key exchange request message to identify a virtual private network associated with a virtual private network in a second type of network; and
in lieu of responding to the key exchange request message and providing encryption key information to the source node, utilize a corresponding forwarding table associated with the virtual private network identified by the unique identifier for purposes forwarding the key exchange request message to a destination node of the virtual private network and support establishment of a secured connection between the source node and the destination node.
